(19) United States
(12) Patent Application Publication
(10) Pub. No.: US 2020/0117476 A1
(43) Pub. Date: Apr. 16, 2020

(54) AUTOMATED CONFIGURATION OF AN APPLICATION INSTANCE

(71) Applicant: SugarCRM Inc., Cupertino, CA (US)

(72) Inventors: Steve Byrne, Vancouver, WA (US); Travis Hubbard, Cupertino, CA (US); Sandhya Jaideep, San Jose, CA (US)

(21) Appl. No.: 16/158,277

(22) Filed: Oct. 11, 2018

(51) Int. Cl. G06F 9/445; H04L 12/24; G06F 8/65; H04L 29/08; H04L 29/06

(52) U.S. Cl. CPC G06F 9/44505; H04L 41/5054; H04L 41/0893; H04L 63/20; H04L 67/22; H04L 67/34; G06F 8/65

(57) ABSTRACT

A method for automated configuration of an application instance includes selecting a set of end users of corresponding instances of an application and classifying each of the end users, logging interactions between each of the end users and the corresponding instances, the grouping together of clusters of the end users according to commonly observed ones of the logged interactions. For each grouping, a configuration common to the end users clustered therein is generated. Thereafter, a request for automated application instance configuration is received from a new end user and, in response to the request, the new end user is classified, one of the set of end users of same classification identified along with a corresponding grouping, and finally, the generated configuration for the corresponding grouping is retrieved and then applied to a new instance of the application for the end user.

### BACKGROUND OF THE INVENTION

### Field of the Invention

The present invention relates to the field of application configuration and more particularly, the automated configuration of an application instance.

### Description of the Related Art

The deployment of a computer program, also referred to as an “application” traditionally involves the transport on physical media of a computer program to a target computing device onto which the program code of the physical media may be transferred. While in some instances, the act of transferring the program code from the physical media to fixed storage of the computing device may suffice as installation of the application, more likely an installation process is required during which different files are transferred from the physical media to the fixed storage of the computing device and programmatic objects extracted therefrom. Even more recently, it is most likely that the programmatic objects are extracted from a “package” received communicatively from over a computer communications network so as to obviate the need for physical media.

Once the programmatic objects have been suitablly stored in the fixed storage of the computing device, one or more instances of the application may be created in memory for use by corresponding end users. That is to say, to the extent the operating system of the computing device permits, multiple different copies of the same application may be placed into respectively different process address spaces of a computing system that includes the computing device and each can execute by one or more processors of the computing system in its own process address memory space independently of the other instances for use by a corresponding end user even though only one application is present in the fixed storage of the computing system.

Of note, simply placing programmatic objects onto the fixed storage of a computing device generally does not result in the end user having the ability to productively utilize a resultant instance of an application. Rather, as it is widely understood, an application instance of an application must first be configured. The configuration of an application instance, however, depending upon the complexity of the underlying application, can be a daunting task. Typical elements of application instance configuration include not only providing personalized information regarding the end user, but also the establishment of security profiles for different end users accessing the application instance, the arrangement of different user interface displays to satisfy the particular end user needs of the end user, the inclusion or exclusion of different program modules depending upon the nature of the functionality required by the end users of the application instance, and even the aggregation of different application instance operations into an automated workflow.

### BRIEF SUMMARY OF THE INVENTION

Embodiments of the present invention address deficiencies of the art in respect to application instance configuration and provide a novel and non-obvious method, system and computer program product for the automated configuration of an application instance based upon the configuration of similarly characterized end users of different instances of the same application. In an embodiment of the invention, a method for automated configuration of an application instance includes selecting a set of end users of corresponding instances of an application and classifying each of the end users. Then interactions between each of the end users in the set and the corresponding instances may be logged and clusters of the end users grouped together according to commonly observed ones of the logged interactions. For each grouping, a configuration common to the end users clustered therein may be generated, such as a set of security settings and/or an automation workflow.

Thereafter, a request for automated application instance configuration is received from a new end user and, in response to the request, the new end user is classified, one of the set of end users of same classification identified along with a corresponding grouping, and finally, the generated configuration for the corresponding grouping is retrieved and then applied to a new instance of the application for the end user. In one aspect of the embodiment, the classification of the end users includes for each of the end users, determining a corresponding industrial segment. As well, in addition or in the alternative, the classifying of the end users includes for each of the end users, determining a corresponding company size. Even further, in addition or in the alternative, the classifying of the end users includes for each of the end users, determining a corresponding business model.

In another aspect of the embodiment, the method additionally includes logging additional interactions between each of the end users in the set and the corresponding instances after having applied the retrieved configuration to the new instance of the application. The, the generated configuration for one of the groupings of the same classification as the new end user may be modified based upon the logged additional interactions between ones of the end users clustered in the one of the groupings. Consequently, the new end user is then prompted to modify the applied configuration to be consistent with the modified generated configuration.

In another embodiment of the invention, a data processing system is configured to provide automated configuration of an application instance of an application, the data processing system. The system includes a host computing system that includes at least one computer with at least one processor and memory communicatively coupled over a computer communications network to a multiplicity of different client computers, the different client computers each providing a user interface to an instance of an application executing in the memory of the host computing system. The system also includes an automated configuration module.

The automation configuration module includes computer program instructions also executing in the memory of the host computing system that are enabled during execution to perform the selection of a set of end users accessing corresponding ones of the instances of the application through respective ones of the different client computers, the classification of each of the end users, the logging of interactions between each of the end users in the set and the corresponding ones of the instances, the grouping together of clusters of the end users according to commonly observed ones of the logged interactions, for each grouping, the generation of a configuration common to the end users clustered therein, the receipt of a request for automated application instance configuration from a new end user through one of the different client computers, and in response to the request, the classifying of the new end user, identifying one of the set of end users of same classification and a corresponding grouping, retrieving the generated configuration for the corresponding grouping and applying the retrieved configuration to a new instance of the application for the end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for the automated configuration of an application instance;

FIG. 2 is a schematic illustration of a data processing system adapted for the automated configuration of an application instance;

FIG. 3A is a flow chart illustrating a process for the logging of customer interactions with different application instances of an application;

FIG. 3B is a flow chart illustrating a process for the processing of the log of FIG. 3A so as to generate groupings of end users according to common patterns of utilization of the application instances; and,

FIG. 3C is a flow chart illustrating a process for the automatic configuration of a new application instance for a new end user using a configuration associated with a grouping of FIG. 3B including an existing end user similar in characterization to the new end user.

### DETAILED DESCRIPTION OF THE INVENTION

Embodiments of the invention provide for the automated configuration of an application instance. In accordance with an embodiment of the invention, different end user interactions with different instances of a common application are recorded and processed to identify common patterns of interactions. End users associated with each common pattern are then classified according to different criteria such as industry, size or location, and grouped together along with a common configuration for the instances of the common application. Thereafter, as a new end user seeks to provision and configure a new instance of the common application, the new end user also is classified and matched to a same or similar classification as one of the existing end users. As such, a grouping for the matched one of the existing end users is identified and a corresponding configuration applied to the new instance of the common application.

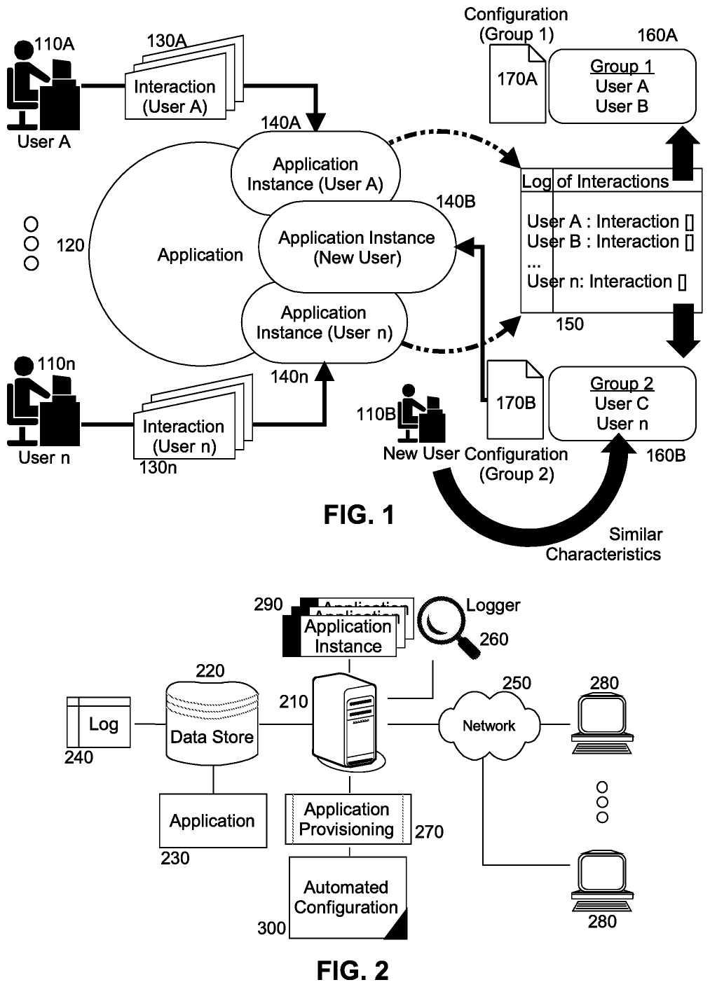

In further illustration, FIG. 1 pictorially shows a process for the automated configuration of an application instance. As shown in FIG. 1, different existing end users 110A, 110n of respectively different instances 140A, 140n of a common application 120 direct different interactions 130A, 130n with corresponding ones of the different instances 140A, 140n such as application commands, application input selections and the like. Each of the end users 110A, 110n is classified according to one or more different characteristics, such as industry, business type, product or service offered, geographic location or business size.

Thereafter, the interactions 130A, 130n are logged in a log of interactions 150 in association with the different end users 110A, 110n. The interactions may include directives to a corresponding one of the instances 140A, 140n, including the generation of different reports, the establishment of one or more security settings, the arrangement of a specific dashboard in a user interface to a corresponding one of the application instances 140A, 140n or the augmentation of a corresponding one of the application instances 140A, 140n with one or more additional modules. The log 150 is then processed to group together into different groups 160A, 160B different ones of the end users 110A, 110n according to common interaction patterns. Each of the groups 160A, 160B is then assigned a common configuration 170A, 170B for different ones of the application instances 140A, 140n of the existing end users 110A, 110n grouped together in a corresponding one of the groups 160A, 160B.

Subsequently, a new end user 110B seeks to provision a new instance 140B of the application 120. In response to a request to provision the new instance 140B of the application 120, the new end user 110B also is classified and then matched to a corresponding one of the existing end users 110A, 110n. Upon matching the new end user 110B to one of the existing end users 110A, 110n, an associated one of the groups 160A, 160B is determined. One of the configurations 170A, 170B is then selected for the associated one of the groups 160A, 160B. Finally, the one of the selected configurations 170A, 170B is applied to the new application instance 140B.

The process described in connection with FIG. 1 may be implemented in a data processing system. In further illustration, FIG. 2 schematically shows a data processing system adapted for the automated configuration of an application instance. The system includes a host computing system 210 that may include one or more computers each with memory and at least one processor. The host computing system 210 includes a data store 220 that may include one or more fixed storage devices adapted to store data including different computer programs and accompanying data files. One such computer program is an application 230. Application provisioning logic 270 executing in the memory of the host computing system 210 is configured to spawn different instances 290 of the application 230 for use by different end users at different client computing devices 280 from over computer communications network 250.

Importantly, a logger 260 also executes in the memory of the host computing system 210 and acts to log in a log 240 in the data store 220, different interactions by different ones of the end users with respectively different ones of the application instances 290 executing in the memory of the host computing system 210. As well, an automated configuration module 300 including computer program instructions operable to execute in the memory of the host computing system 210 acts upon the log 240 by characterizing the different end users and grouping the end users together into different groups according to common patterns of interaction with respective ones of the applications instances 290.

As such, the program instructions of the automated configuration module 300 are enabled during execution to receive a request to configure a new one of the application instances 290 on behalf of a new end user. In response to the request, the program instructions of the automated configuration module 300 are enabled to classify the new end user and locate a similarly characterized one of the different end users. Upon locating a similarly characterized one of the different end users, the program instructions are enabled to select a corresponding one of the groups for the located one of the different end users and retrieve an associated configuration. Finally, the program instructions are operable to apply the associated configuration to the new one of the application instances 290.

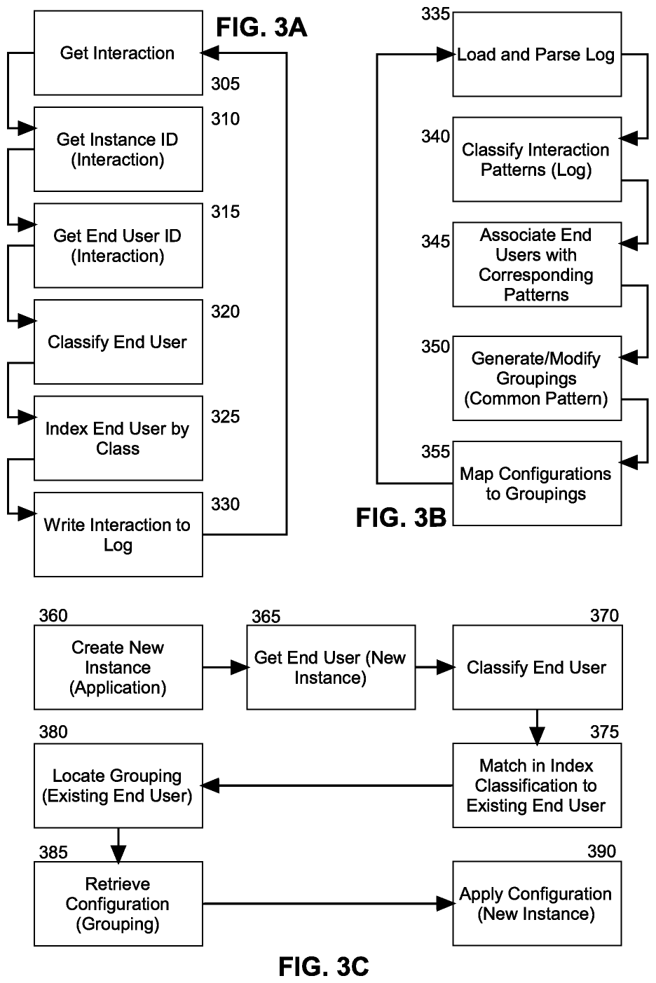

In yet further illustration of the operation of the automated configuration module 300, FIG. 3A is a flow chart illustrating a process for the logging of customer interactions with different application instances of an application. Beginning in block 305, an interaction is observed as between an existing end user and an instance of an application. In block 310, an identification of the application instance is determined and in block 315, an identification of the existing end user is determined. In block 320, the end user is classified according to one or more characterizations of the end user such as industry, product or service type, geographic location and the like. Then, in block 325, the end user is indexed by classification. Finally, in block 330 the interaction is written to the log and the process can repeat for a next observed interaction.

Turning now to FIG. 3B, in block 335, the log is loaded into memory and processed. In processing the log, in block 340 the interactions of the log are reviewed to identify different patterns of interactions by different corresponding end users. In block 345 each of the different patterns are associated with corresponding different end users and in block 350, ones of the different end user exhibiting common patterns of interaction are grouped together. Finally, in block 355, each of the groups is assigned a corresponding configuration for an instance of the applications associated with those of the end users of a corresponding one of the groups. Thereafter, the process can repeat for a modified form of the log such that the groupings constantly are adjusted based upon the observed interactions of the log.

Turning now to FIG. 3C, in block 360, a new instance of the application is provisioned on behalf of a new end user and in block 365 the identity of the new end user is determined. In block 370, the new end user is classified and in block 375, the classification of the new end user is matched to a classification of an existing end user in the index. As such, in block 380, a grouping for the existing end user of the matched classifications is located and in block 385, a configuration for the grouping is retrieved. Finally, in block 390 the retrieved configuration is applied to the new instance of the application.

FIG. 3B is a flow chart illustrating a process for the processing of the log of FIG. 3A so as to generate groupings of end users according to common patterns of utilization of the application instances; and,

FIG. 3C is a flow chart illustrating a process for the automatic configuration of a new application instance for a new end user using a configuration associated with a grouping of FIG. 3B including an existing end user similar in characterization to the new end user.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated configuration of an application instance comprising:
selecting a set of end users of corresponding instances of an application;
classifying each of the end users;
logging interactions between each of the end users in the set and the corresponding instances;
grouping together clusters of the end users according to commonly observed ones of the logged interactions;
for each grouping, generating a configuration common to the end users clustered therein;
receiving a request for automated application instance configuration from a new end user; and,
responsive to the request, classifying the new end user, identifying one of the set of end users of same classification and a corresponding grouping, retrieving the generated configuration for the corresponding grouping and applying the retrieved configuration to a new instance of the application for the end user.

2. The method of claim 1, wherein the classifying of the end users includes for each of the end users, determining a corresponding industrial segment.

3. The method of claim 1, wherein the classifying of the end users includes for each of the end users, determining a corresponding company size.

4. The method of claim 1, wherein the classifying of the end users includes for each of the end users, determining a corresponding business model.

5. The method of claim 1, further comprising:
logging additional interactions between each of the end users in the set and the corresponding instances after having applied the retrieved configuration to the new instance of the application;
modifying the generated configuration for one of the groupings of the same classification as the new end user based upon the logged additional interactions between ones of the end users clustered in the one of the groupings; and,
prompting the new end user to modify the applied configuration to be consistent with the modified generated configuration.

6. The method of claim 1, wherein each generated configuration includes at least a set of security settings and an automation workflow.

7. A data processing system configured to provide automated configuration of an application instance of an application, the data processing system comprising:
a host computing system that includes at least one computer with at least one processor and memory communicatively coupled over a computer communications network to a multiplicity of different client computers, the different client computers each providing a user interface to an instance of an application executing in the memory of the host computing system;
an automated configuration module comprising computer program instructions also executing in the memory of the host computing system, the computer program instructions enabled during execution to perform:
selecting a set of end users accessing corresponding ones of the instances of the application through respective ones of the different client computers;
classifying each of the end users;
logging interactions between each of the end users in the set and the corresponding ones of the instances;
grouping together clusters of the end users according to commonly observed ones of the logged interactions;
for each grouping, generating a configuration common to the end users clustered therein;
receiving a request for automated application instance configuration from a new end user through one of the different client computers; and,
responsive to the request, classifying the new end user, identifying one of the set of end users of same classification and a corresponding grouping, retrieving the generated configuration for the corresponding grouping and applying the retrieved configuration to a new instance of the application for the end user.

8. The system of claim 7, wherein the classifying of the end users includes for each of the end users, determining a corresponding industrial segment.

9. The system of claim 7, wherein the classifying of the end users includes for each of the end users, determining a corresponding company size.

10. The system of claim 7, wherein the classifying of the end users includes for each of the end users, determining a corresponding business model.

11. The system of claim 7, wherein the program instructions are further enabled to perform:
logging additional interactions between each of the end users in the set and the corresponding instances after having applied the retrieved configuration to the new instance of the application;
modifying the generated configuration for one of the groupings of the same classification as the new end user based upon the logged additional interactions between ones of the end users clustered in the one of the groupings; and,
prompting the new end user to modify the applied configuration to be consistent with the modified generated configuration.

12. The system of claim 7, wherein each generated configuration includes at least a set of security settings and an automation workflow.

13. A computer program product for automated configuration of an application instance, the computer program product including a computer readable storage medium having program instructions embodied therewith, the program instructions executable by a device to cause the device to perform a method including:
selecting a set of end users of corresponding instances of an application;
classifying each of the end users;
logging interactions between each of the end users in the set and the corresponding instances;
grouping together clusters of the end users according to commonly observed ones of the logged interactions;
for each grouping, generating a configuration common to the end users clustered therein;
receiving a request for automated application instance configuration from a new end user; and,
responsive to the request, classifying the new end user, identifying one of the set of end users of same classification and a corresponding grouping, retrieving the generated configuration for the corresponding grouping and applying the retrieved configuration to a new instance of the application for the end user.

14. The computer program product of claim 13, wherein the classifying of the end users includes for each of the end users, determining a corresponding industrial segment.

15. The computer program product of claim 13, wherein the classifying of the end users includes for each of the end users, determining a corresponding company size.

16. The computer program product of claim 13, wherein the classifying of the end users includes for each of the end users, determining a corresponding business model.

17. The computer program product of claim 13, wherein the method further comprises:
logging additional interactions between each of the end users in the set and the corresponding instances after having applied the retrieved configuration to the new instance of the application;
modifying the generated configuration for one of the groupings of the same classification as the new end user based upon the logged additional interactions between ones of the end users clustered in the one of the groupings; and,
prompting the new end user to modify the applied configuration to be consistent with the modified generated configuration.

18. The computer program product of claim 13, wherein each generated configuration includes at least a set of security settings and an automation workflow.
